(19) United States
(12) Patent Application Publication
(10) Pub. No.: US 2015/0209236 A1
(43) Pub. Date: Jul. 30, 2015

(54) THREE AND FOUR WAY PILL CUTTER

(71) Applicant: Harshad Manilal PATEL, Taunton, MA (US)

(72) Inventor: Harshad Manilal PATEL, Taunton, MA (US)

(21) Appl. No.: 14/596,701

(22) Filed: Jan. 14, 2015

Related U.S. Application Data
(60) Provisional application No. 61/933,153, filed on Jan. 29, 2014.

(51) Int. Cl. A61J 7/00

(52) U.S. Cl. CPC A61J 7/0007

(57) ABSTRACT

A pill cutter is provided. The pill cutter includes an upper half and a lower half pivotally connected to one another. Each of the upper half and lower half includes an inner surface and an outer surface, with the inner surfaces facing one another. The pill cutter further includes a pill platform attached to the inner surface of the lower half and formed to receive a pill. A blade holder is formed on the inner surface of the upper half. The blade holder includes a blade slot shaped to receive at least one of a three way cutter blade and a four way cutter blade.

### CROSS-REFERENCE TO RELATED APPLICATION

This application claims the benefit of priority of U.S. provisional application number 61/933,153, filed Jan. 29, 2014, the contents of which are herein incorporated by reference.

### BACKGROUND OF THE INVENTION

The present invention relates to a pill cutter and, more particularly, to a three and four way pill cutter.

Pill-splitting refers to the practice of splitting a tablet or pill to provide a lower dose of the active ingredient, or to obtain multiple smaller doses, either to reduce cost or because the pills available provide a larger dose than required. Many pills that are suitable for splitting come pre-scored so that they may easily be halved.

A pill-splitter is a simple and inexpensive device to split medicinal pills or tablets, comprising some means of holding the tablet in place, a blade, and usually a compartment in which to store the unused part. The tablet is positioned, and the blade pressed down to split it. To split the pill into quarters, a user must split a pill that has already been halved. This is difficult to do and often the pill is out of position and improperly cut. Dividing a pill into three parts is even more difficult.

As can be seen, there is a need for a pill cutter that may be used to properly divide a pill into three or four parts.

### SUMMARY OF THE INVENTION

In one aspect of the present invention, a pill cutter comprises: an upper half comprising an inner surface and an outer surface; a lower half comprising an inner surface and an outer surface, wherein the lower half is pivotally attached to the upper half and the inner surface of the upper half is facing the inner surface of the lower half; a pill platform attached to the inner surface of the lower half and formed to receive a pill; and a blade holder formed on the inner surface of the upper half and comprising a blade slot, wherein the blade slot is shaped to receive at least one of a three way cutter blade and a four way cutter blade.

In another aspect of the present invention, a pill cutter comprises: an upper half comprising an inner surface and an outer surface; a lower half comprising an inner surface and an outer surface, wherein the lower half is pivotally attached to the upper half and the inner surface of the upper half is facing the inner surface of the lower half; a pill platform attached to the inner surface of the lower half and formed to receive a pill; and a blade holder formed on the inner surface of the upper half and comprising a blade slot, wherein the blade slot is at least one of a Y-shape and a cross shape formed to receive at least one of a corresponding Y-shaped three way cutter blade and a cross shaped four way cutter blade.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention in the closed position;

FIG. 2 is a perspective view of an embodiment of the present invention in the open position;

FIG. 3 is a top exploded view of an embodiment of the present invention;

FIG. 4 is a bottom exploded view of an embodiment of the present invention;

FIG. 5 is a section view of an embodiment of the present invention, taken along line 5-5 in FIG. 1;

FIG. 6 is a section view of an embodiment of the present invention, illustrating the opening of the upper half;

FIG. 7 is a section view of an embodiment of the present invention, taken along line 7-7 in FIG. 5;

FIG. 8 is a section view of an embodiment of the present invention, taken along line 8-8 in FIG. 5;

FIG. 9 is a detail section view of an embodiment of the present invention;

FIG. 10 is a detail section view of an embodiment of the present invention, taken along line 10-10 in FIG. 8;

FIG. 11 is a perspective view of the three-way cutter; and

FIG. 12 is a detail bottom exploded view of an embodiment of the present invention with three-way cutter.

### DETAILED DESCRIPTION OF THE INVENTION

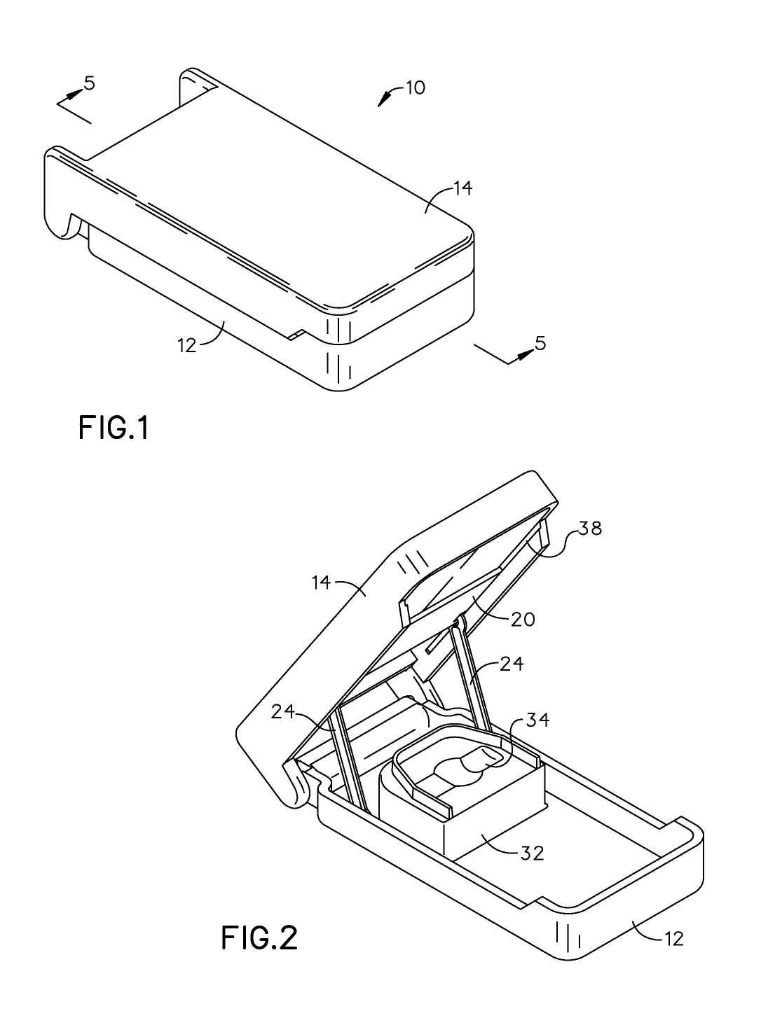

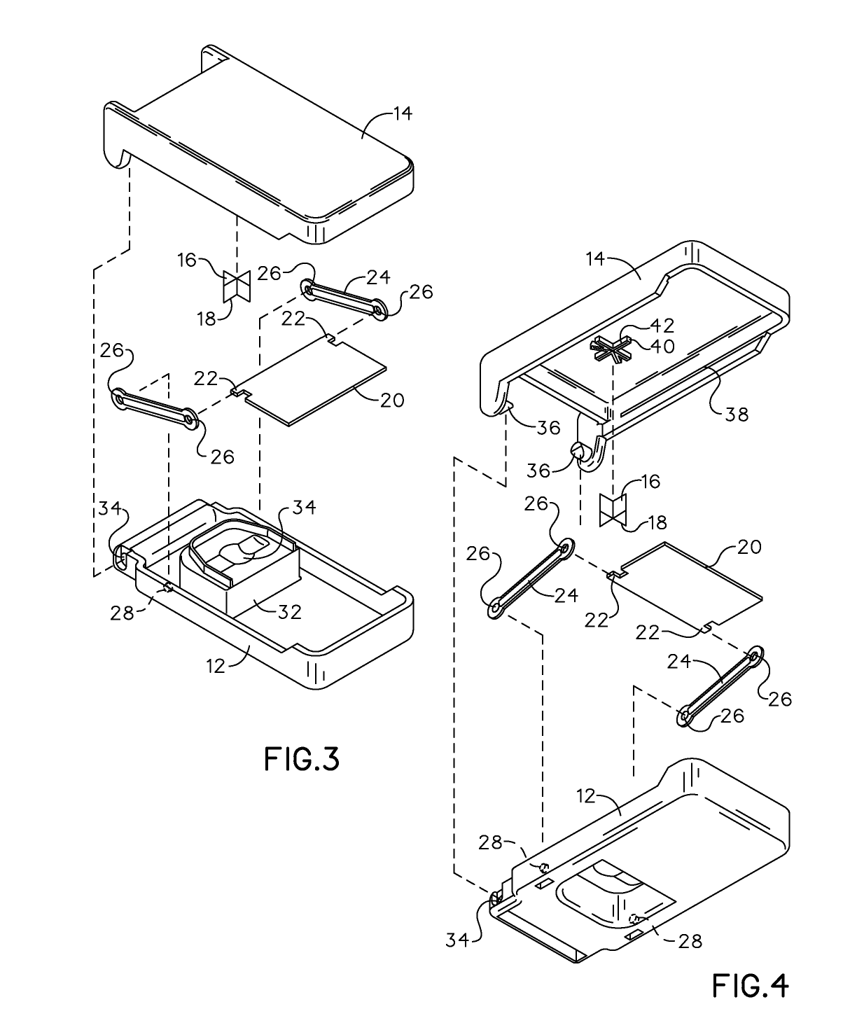

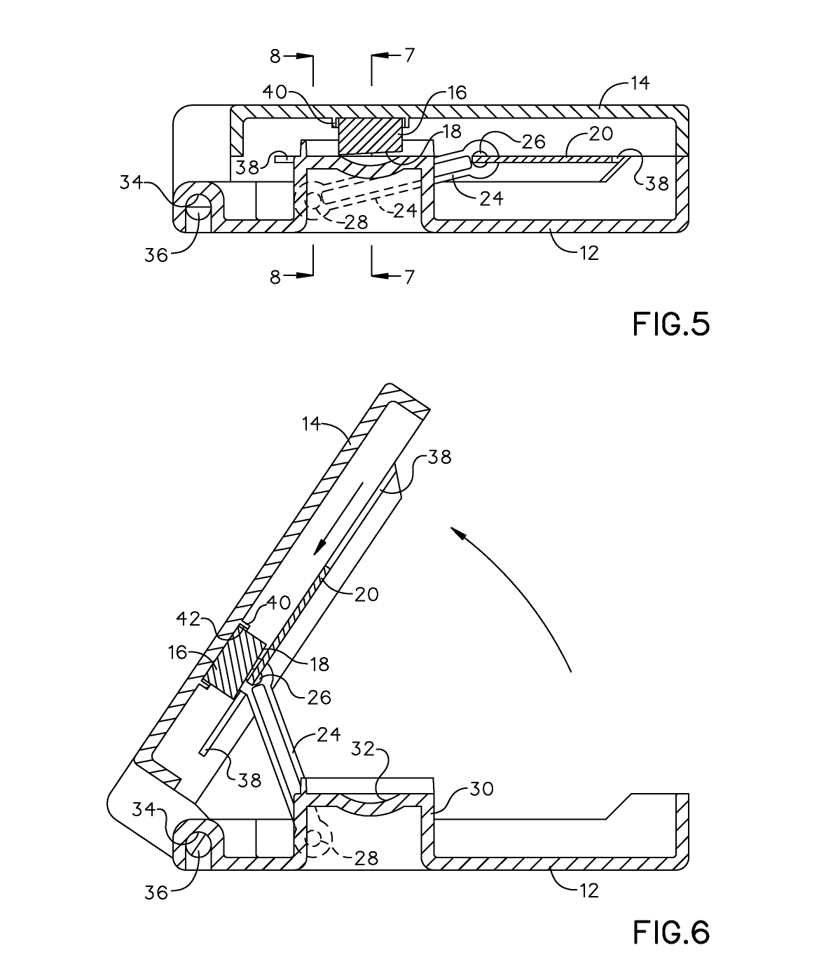

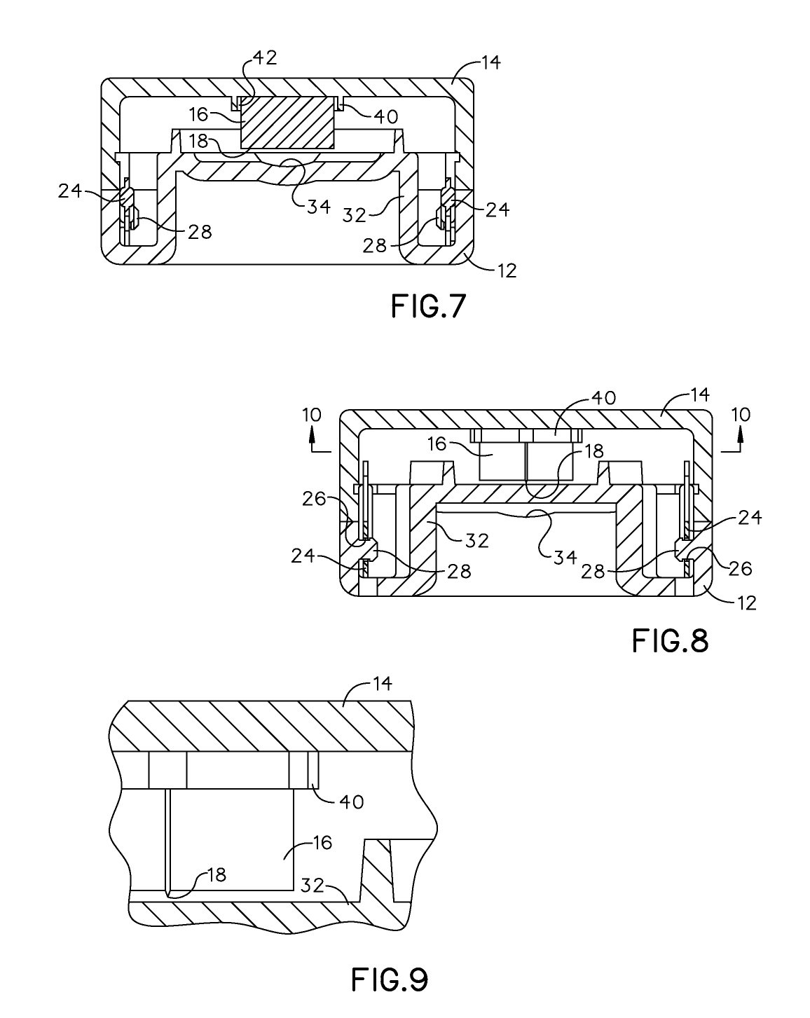

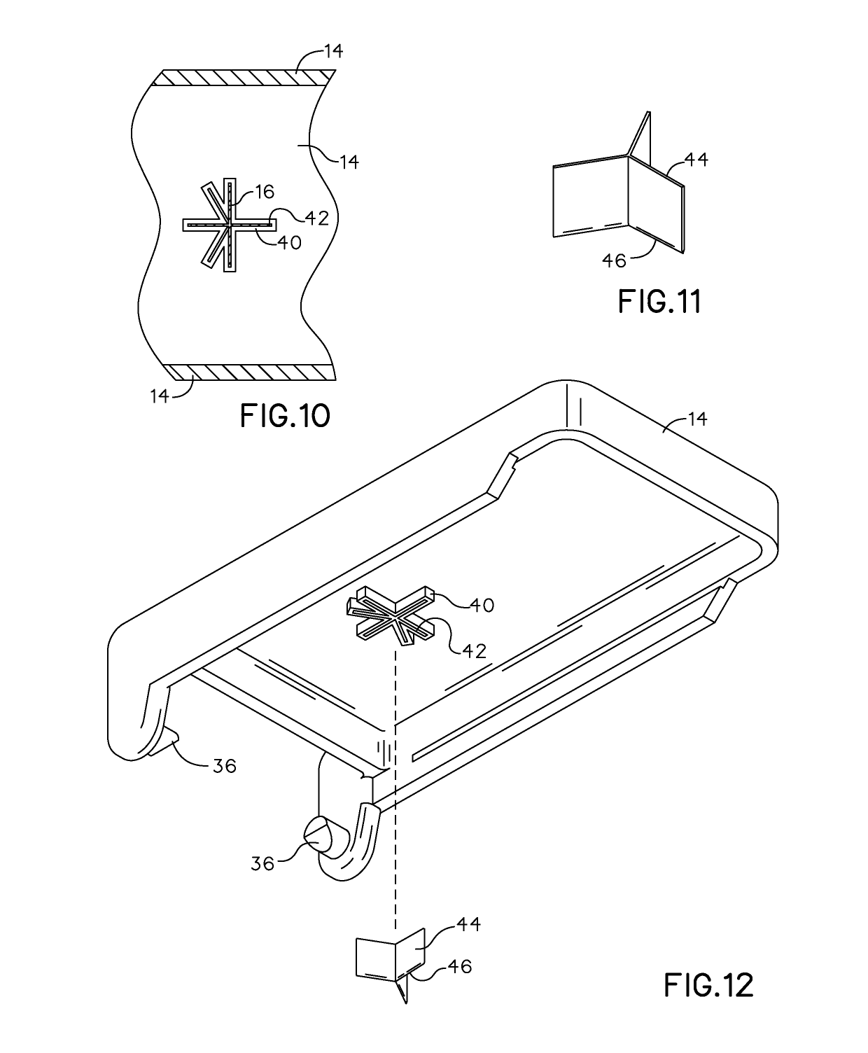

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Referring to FIGS. 1 through 12, the present invention includes a pill cutter 10. The pill cutter 10 includes an upper half 14 and a lower half 12 pivotally connected to one another. Each of the upper half 14 and lower half 12 includes an inner surface and an outer surface, with the inner surfaces facing one another. The pill cutter 10 further includes a pill platform 30 attached to the inner surface of the lower half 12 and formed to receive a pill. A blade holder 40 is formed on the inner surface of the upper half 14. The blade holder 40 includes a blade slot 42 shaped to receive at least one of a three way cutter blade 44 and a four way cutter blade 16.

In certain embodiments, the upper half 14 may include hinge posts 36 that fit into corresponding hinge slots 34 of the lower half 12, thereby pivotally connecting the two. The pill cutter 10 includes an open position and closed position. The closed position includes the blade holder 40 and the pill platform 30 pivoted towards one another, and the open position includes the blade holder 40 and the pill platform 30 pivoted away from one another. Therefore, the pill cutter 10 may be opened, a pill may be placed on the pill platform 30, and the upper and lower halves 12, 14 may be pivoted towards one another. The blade holder 40 and therefore the blade 16, 44 are positioned above the pill platform 30 so that the blade 16, 44 may cut the pill when the pill cutter 10 is pivoted into the closed position.

The three way cutter blade 44 is Y-shaped and the four way cutter blade 16 is cross (+) shaped. The blade angle of the three way cutter blade 44 may be 120 degrees and the blade angle of the four way cutter 16 may be 90 degrees. The blade slot 42 may be shaped to correspond with the cutter blades 44 16. Therefore, the blade slot 42 may be Y-shaped or cross shaped. As illustrated in the Figures, the blade slot 42 may include both a Y-shape and a cross shape. Therefore, the blades 44, 16 may be removed and interchanged depending on whether the user desires to cut the pill into three or four pieces. Further, a straight line is formed in the cross shape. Therefore, a straight line blade may also be inserted into the blade slot 42 of the present invention to cut the pill into halves.

The pill platform 30 of the present invention may be formed in the lower half 12 of the pill cutter 10. The pill platform 30 may be raised towards the upper half 14. A pill slot 32 may be formed on the top of the pill platform 30 to secure a pill within. In certain embodiments, a thin layer of latex material may cover the pill slot 32 to further secure the pill within. A pill bumper may also be disposed on the top of the pill platform 30 to further secure the pill. The blade slot 42 is aligned above the pill slot 32 in the closed position so that cutting edges 18, 46 of the blades 16, 44 penetrate and cut the pill within the pill slot 32.

In certain embodiments, the upper half 14 and the lower half 12 may each include flanges about the edges and protruding towards one another. The flanges of the upper and lower half 14, 12 may interlock and therefore when the pill cutter is in the closed position, the flanges may form a sealed housing in between the upper and lower halves 14, 12. Therefore, when the pill cutter 10 is used to cut a pill, the cut pill is contained within the pill cutter 10.

The present invention may further include a blade safety mechanism. The blade safety mechanism includes a pair of links 24 each having a first end and a second end. The first end and the second end may each include openings 26. The opening 26 on the first end may receive posts 28 protruding from the flange of the lower half 12, and may thereby pivotally connect with the lower half 12. The blade safety mechanism further includes a shield 20. The edges of the shield 20 slidably engage with slots 38 formed in the flanges of the upper half 14. The openings 26 of the second ends of the links 24 may receive shield tabs 22 protruding from the shield 20 and thereby pivotally attaching the links 24 and the shield 20. The shield 20 slides along the pair of slots 38 and covers the blade holder 40 in the open position and exposes the blade holder 40 in the closed position.

It should be understood, of course, that the foregoing relates to exemplary embodiments of the invention and that modifications may be made without departing from the spirit and scope of the invention as set forth in the following claims.

What is claimed is:

1. A pill cutter comprising:
an upper half comprising an inner surface and an outer surface;
a lower half comprising an inner surface and an outer surface, wherein the lower half is pivotally attached to the upper half and the inner surface of the upper half is facing the inner surface of the lower half;
a pill platform attached to the inner surface of the lower half and formed to receive a pill; and
a blade holder formed on the inner surface of the upper half and comprising a blade slot, wherein the blade slot is shaped to receive at least one of a three way cutter blade and a four way cutter blade.

2. The pill cutter of claim 1, wherein the three way cutter blade is Y-shaped and the four way cutter blade is cross shaped.

3. The pill cutter of claim 2, wherein the blade slot of the blade holder is at least one of Y-shaped and cross shaped.

4. The pill cutter of claim 1, comprising an open position and closed position, wherein the closed position comprises the blade holder and the pill platform pivoted towards one another, and the open position comprises the blade holder and the pill platform pivoted away from one another.

5. The pill cutter of claim 4, further comprising a blade safety mechanism comprising:
a pair of links each comprising a first end and a second end, wherein the first ends are pivotally attached to the lower half; and
a shield slidably engaged within a pair of slots formed on the upper half, wherein the second ends are pivotally attached to the shield,
wherein the shield slides along the pair of slots and covers the blade holder in the open position and exposes the blade holder in the closed position.

6. The pill cutter of claim 5, wherein the upper half comprises a pair of flanges extending downward towards the lower half on opposing sides, wherein each of the flanges comprise a slot of the pair of slots.

7. A pill cutter comprising:
an upper half comprising an inner surface and an outer surface;
a lower half comprising an inner surface and an outer surface, wherein the lower half is pivotally attached to the upper half and the inner surface of the upper half is facing the inner surface of the lower half;
a pill platform attached to the inner surface of the lower half and formed to receive a pill; and
a blade holder formed on the inner surface of the upper half and comprising a blade slot, wherein the blade slot is at least one of a Y-shape and a cross shape formed to receive at least one of a corresponding Y-shaped three way cutter blade and a cross shaped four way cutter blade.

8. The pill cutter of claim 7, wherein the blade slot of the blade holder forms both the Y-shape and the cross shape.

9. The pill cutter of claim 7, comprising an open position and closed position, wherein the closed position comprises the blade holder and the pill platform pivoted towards one another, and the open position comprises the blade holder and the pill platform pivoted away from one another.

10. The pill cutter of claim 9, further comprising a blade safety mechanism comprising:
a pair of links each comprising a first end and a second end, wherein the first ends are pivotally attached to the lower half; and
a shield slidably engaged within a pair of slots formed on the upper half, wherein the second ends are pivotally attached to the shield,
wherein the shield slides along the pair of slots and covers the blade holder in the open position and exposes the blade holder in the closed position.
